(19) United States
(12) Patent Application Publication
(10) Pub. No.: US 2012/0248224 A1
(43) Pub. Date: Oct. 4, 2012

(54) FLUID DELIVERY SYSTEM AND A VALVE SYSTEM THEREFOR

(75) Inventor: Steven Wayne Jones, Worcestershire (GB)

(73) Assignee: AQUA-DAPTER LIMITED, West Midlands (GB)

(21) Appl. No.: 13/514,788

(22) PCT Filed: Dec. 8, 2010
(86) PCT No.: PCT/GB2010/052050

§ 371 Date: Jun. 8, 2012

(30) Foreign Application Priority Data
Dec. 8, 2009 (GB) 0921472.7

(51) Int. Cl. B05B 15/06

(52) U.S. Cl. 239/532

(57) ABSTRACT

A fluid delivery system is provided that includes a telescopic pole, a valve, and an element for operating the valve. The telescopic pole has a hose running therethrough. The pole has a distal end connected to or including a dispensing head. The valve controls the flow of fluid from the hose to the dispensing head. The element is located at the proximal end portion of the pole and remains at the proximal end portion as the telescopic pole is extended and retracted.

This invention concerns a fluid delivery system comprising a telescopic pole and a valve system therefor. The invention has particular, but not exclusive, application to a system comprising a telescopic water fed pole for use in window cleaning.

It is common for a window cleaner to use a system comprising a telescopic water fed pole having a brush mounted thereon for cleaning windows above the ground floor. Water is fed up a hose running through the pole, an end of the hose fluidly connected to the brush such that water is dispensed through a series of outlets in the brush for dispensing the water onto a window. The other end of the hose is connected to, typically, a relatively remote water supply. To allow for the telescopic motion of the pole, the hose enters the pole at a lower end of the pole and a length of hose located in the pole at any one time depends on the current extension of the telescopic pole. Excess hose may be coiled up on the floor or otherwise be available on extension of the telescopic pole. In use, the cleaner grips a lower end portion of the pole and extends and retracts the telescopic pole depending on the height of the window being cleaned.

It is typical that for the cleaner to switch off the supply of water, the cleaner must operate a tap, or the like, of the water supply that is remote from windows being cleaned (i.e. out of reach of the cleaner when cleaning the windows). Accordingly, if the cleaner wants the pole to remain extended, the cleaner must find a way of securing the extended pole to allow the cleaner to let go of the pole and turn off the water supply using the remote tap. This can lead to unsafe scenarios, such as the cleaner leaning the extended pole up against a building where the pole can be blown or knocked down, in order to turn off the water supply.

In order to avoid such safety hazards, it is typical for the cleaner not to switch off the water supply as he/she moves from one window to the next, wasting water. When considering that the water used for cleaning windows is obtained by filtering water supplied, typically, by a public utility, through an ionic resin filter to obtain water suitable for cleaning windows such that 850 litres of unfiltered water provides 100 litres of filtered water, even small amounts of filtered water wasted by the cleaner amounts to a large waste in unfiltered water.

To mitigate this problem, it is known to provide a valve in the hose such that the cleaner can control the supply of water in the local vicinity of the pole. However, the valve will be located on the floor with the excess hose, such that to operate the valve the cleaner must either let go of the pole, leading to the safety problems already discussed above, or attempt to lean over and operate the valve located on the floor with one hand whilst gripping the pole with the other to keep the pole upright. For poles that have been extended significantly, it is clear that whilst leaning over to operate the valve the cleaner cannot safely control the pole with the other hand, resulting in a safety hazard.

According to a first aspect of the invention there is provided a fluid delivery system comprising a telescopic pole having a hose running therethrough, a distal end of the pole arranged to be connected to or comprising a dispensing head; a valve for controlling the flow of fluid from the hose to the dispensing head and an element located at a proximal end portion of the pole for operating the valve, the element arranged to remain located at the proximal end portion of the pole as the telescopic pole is extended and retracted.

It will be understood that the term “located at the proximal end portion of the pole” is intended to include the element being located a short distance beyond the end of the pole, i.e., when the user is standing up holding the proximal end of the pole, the element is within arms reach.

The fluid delivery system according to the invention may allow a user to control the fluid flow, e.g. the flow of water, without having to release the pole or hold the pole in an unsafe manner as the element for operating the valve remains within reach of the user at a proximal end of the pole when the pole is retracted and extended. Accordingly, a cleaner using the fluid delivery system according to the invention may switch off the flow of water more regularly, such as when he/she moves between windows, saving water and reducing the amount of ionic resin required to filter the water.

In one embodiment, the element for operating the valve is the hose itself, the hose connected to the valve such that pulling on the hose operates the valve. As the hose enters the pole at the proximal end portion of the pole, in use a portion of the hose will always be available at the proximal end portion of the pole for the user to operate the valve. In the preferred embodiment, the hose enters the pole at the proximal end, however it will be understood that hose may enter the pole at a hole located in the side of the proximal end portion of the pole.

In another embodiment, the element for operating the valve is a mechanical linkage, such as cord, wire or the like, located within or external to the pole, other than the hose. In a further embodiment, the element is a wireless transmitter located at the proximal end of the pole. However, electronic solutions are less desirable due to the presence of fluid, such as water, that could lead to an electrical safety hazard.

The key requirement is that the element for operating the valve is arranged to remain at the proximal end portion of the pole when the telescopic pole is extended and retracted.

The valve may be located at a distal end portion of the pole and may be arranged to fluidly connect the hose to the dispensing head. By locating the valve at a distal end portion of the pole and between the hose and the dispense head, the valve does not hinder extension and retraction of the pole. If the valve is located elsewhere then it may limit the extent to which the pole can be retracted, in use.

It will be understood that the term “located at a distal end portion of the pole” is meant to include the valve being an extension to the pole. Accordingly, the dispense head may be directly connected to the pole or indirectly connected to the pole via the valve/a valve housing.

The telescopic pole comprises a series of sliding tube sections. The valve may be located within or connected to a distal tube section (i.e. distal from the user) of the pole. The element for operating the valve may be located at a proximal tube section of the pole to be gripped by the user.

In one embodiment, the valve is arranged for sliding movement, movement of the valve causing the valve to switch between an on state allowing fluid flow to the dispense head and an off state preventing fluid flow to the dispense head. The valve and hose may be arranged such that the user pulling on the hose causes sliding movement of the valve.

The system may comprise a valve activation mechanism responsive to the sliding movement of the valve to switch the valve between the on and off states. A valve member of the valve may be operated by rotation, such as a ball valve, and the valve activation mechanism is arranged to convert linear sliding movement of the valve into rotational movement of the valve member.

The valve activation mechanism may comprise a ratchet type mechanism that causes sufficient rotational movement of the valve member to switch states when the valve slides in one linear direction but not the other. The valve activation mechanism may comprise a plurality of radial arms connected with the valve member and an abutment member arranged such that movement of the valve in one linear direction causes one of the plurality of arms to catch on the abutment member to convert the sliding movement into sufficient rotation of the valve member to cause the valve to change states, whereas upon movement of the valve in the other linear direction the arm slides over the abutment member such that any resultant rotation of the valve member is insufficient to cause the valve to change states. The plurality of arms and/or the abutment member may be arranged to resiliently deform or pivot on engagement with the abutment member/one of the plurality of arms to allow the arm to slide past the abutment member. (A pivoted abutment member may also be termed a pawl).

The valve may be biased, for example by a spring in the linear direction away from the proximal end portion of the pole. In this way, the valve moves back to its original position after the user has moved the valve, for example by pulling the hose, to switch states.

In other embodiments, the valve may be of another type, such as a valve that prevents the flow of fluid to the dispense head by squeezing the tube. The hose may be able to move relative to such a valve such that the valve can be located at the proximal end portion of the pole without limiting telescopic movement of the pole.

The valve may be operated by another kind of valve activation mechanism such as a motor or the like.

According to a second aspect of the invention there is provided a valve system for a fluid delivery system according to the first aspect of the invention, the valve system comprising a valve for insertion in or on the telescopic pole and for connection to the hose such that the valve is caused to switch states when the hose is pulled by the user.

According to a third aspect of the invention there is provided a kit of parts for forming a valve system comprising a valve activation mechanism connectable to a valve received in a housing such that the valve can slide therein, the valve activation mechanism arranged to be responsive to the sliding movement of the valve to switch the valve between the on and off states.

In one embodiment the kit of parts may include the valve, however in another embodiment the valve may be a standard valve that is supplied separately or a valve recycled from a previous valve system. In particular, it is envisaged that the valve may outlast the valve activation mechanism and therefore, the valve activation mechanism may require replacement before the valve.

Furthermore, the kit of parts may comprise the housing but again it is envisaged that the housing may outlast the valve activation mechanism and therefore, a replacement kit of parts without the housing may be required.

Embodiments of the invention will now be described, by example only, with reference to the accompanying drawings, in which:

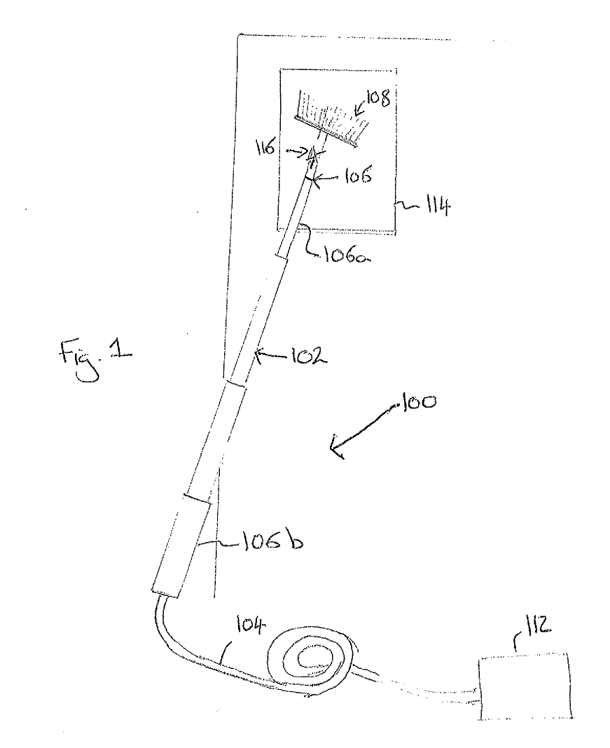

FIG. 1 is a schematic of a fluid delivery system according to an embodiment of the invention;

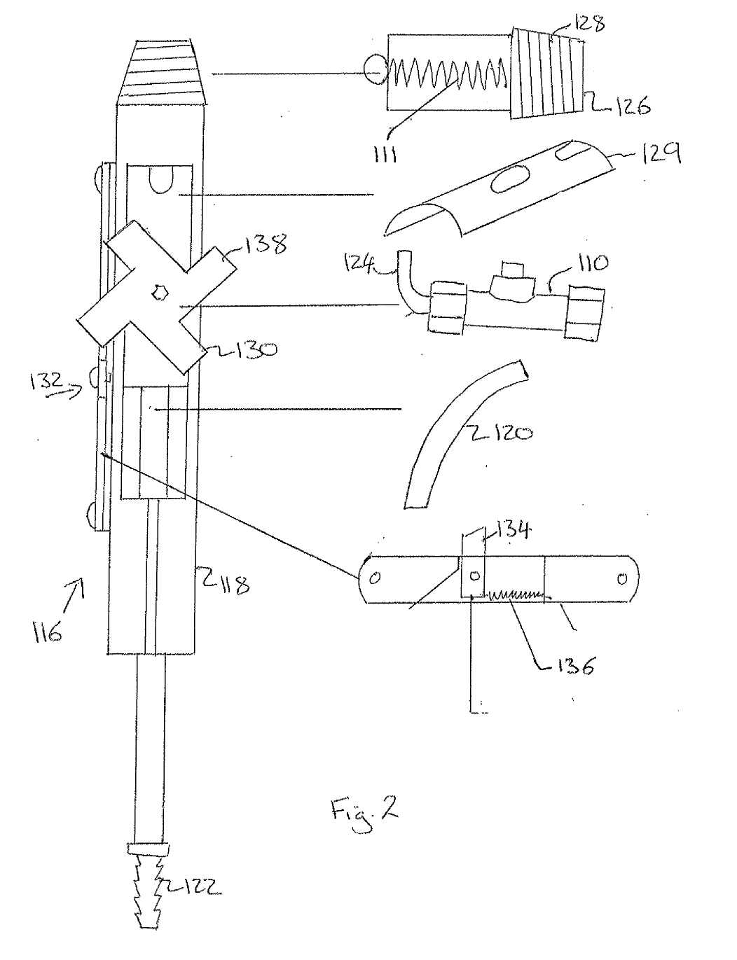

FIG. 2 shows a side view of valve system used in the fluid delivery system shown in FIG. 1 and component parts of the valve system; and

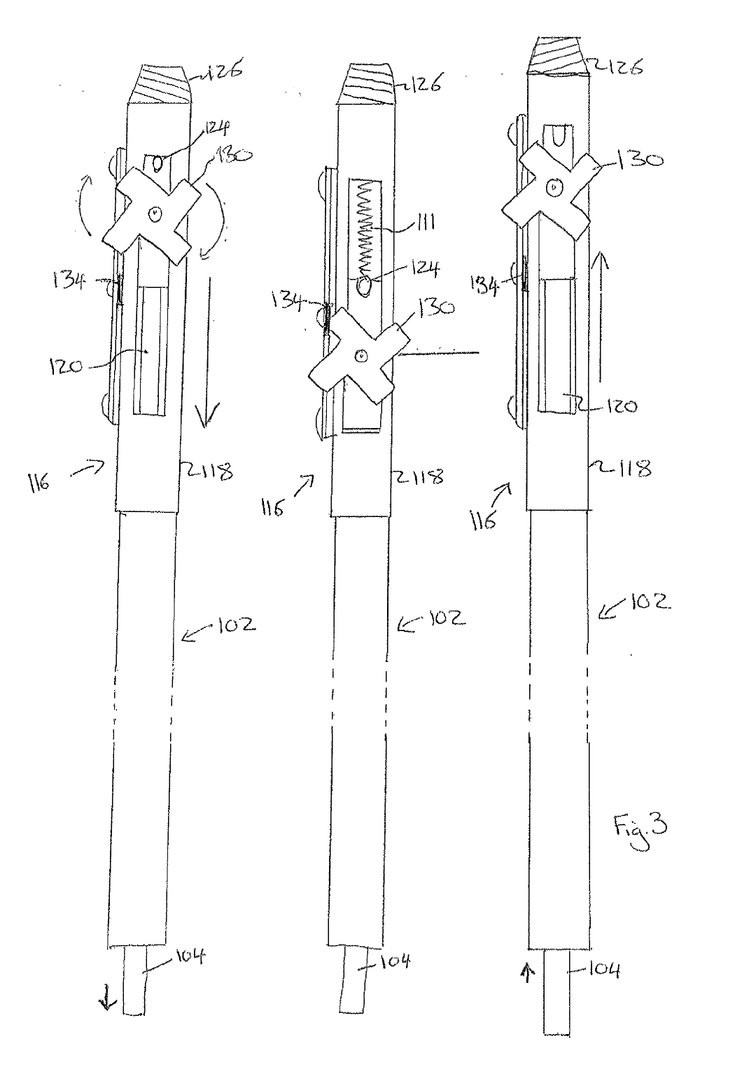

FIG. 3 shows a side view of the fluid delivery system shown in FIG. 1 during operation.

Referring to the Figures, a fluid delivery system 100 comprises a telescopic pole 102 having a hose 104 running therethrough, a distal end 106 of the pole 102 arranged to be connected to a dispensing head 108. One end of the hose 104 is connected to the dispensing head 108 via a valve 110 for controlling the flow of fluid from the hose 104 to the dispensing head 108. The other end of the hose is connected to a water supply 112. The water supply supplies “clean” water for cleaning windows 114, such as water filtered using an ionic filter.

The telescopic pole 102 comprises a series of sliding tube sections. The valve 110 may be located within the tube section 106a of the pole 102 to which the dispensing head 108 is connected or connectable. However, in this embodiment, the valve 110 is part of a valve system 116 that can be retrofitted to the distal end of existing telescopic poles 102.

The valve system 116 comprises valve 110, in this embodiment a ball valve, arranged for sliding movement under the biasing of a spring 111 within a housing 118. At one end the valve 110 is connected to a first valve hose 120 such that movement of the valve hose 120 downwards causes movement of the valve 110 within the housing 118. The end of the first valve hose 120 comprises a suitable connection 122 for connecting the first valve hose 120 to the hose 104. The other end of the valve 116 is connected to a second valve hose (not shown) for connecting the valve 116 in fluid communication with the dispensing head 108. The second value hose is connected to the valve 116 via elbow joint 124. End 126 comprises a screw thread 128 such that a dispensing head, such as a brush, can be connected to the end 126. When the valve 110 is located towards end 126 of the valve system 116, the second valve hose is of a length so as to form a kink or elbow therein. When the valve 110 is moved away from end 126, slack in the second valve hose is taken up such that the second valve hose is substantially straight or at least has less of a kink or elbow therein. A U-shaped plate 129 may be placed over valve 110 to aid sliding movement of the valve 110 in the housing 118.

Connected to a valve member (not shown) of the ball valve 110 is a ratchet 130 of a valve activation mechanism 132. The valve activation mechanism 132 further comprises a pivoted abutment member (pawl) 134 biased, in this embodiment by spring 136, to an upright position perpendicular to a longitudinal axis of the housing 118. The ratchet 130 has, in this embodiment, four radial arms 138 that engage with the pawl 134 upon sliding movement of the valve 110.

In use, movement of the valve 110 in one linear direction, in this embodiment away from end 126, causes one of the plurality of arms to catch on the pawl 134 to convert the sliding movement into sufficient rotation of the valve member to cause the valve 110 to change states (e.g. to block or allow flow). However, upon movement of the valve 110 under the biasing of spring 111, from the other extreme, in a linear direction towards the end 126, the arm 138 contacts the pawl 134 causing the pawl to pivot against the biasing of the spring 136 such that the contacting arm 138 slides over the pawl 134 and any resultant rotation of the valve member is insufficient to cause the valve to change states. Accordingly, movement of the valve 110 towards end 126 does not cause the valve 110 to change states.

In use, the valve system 116 is connected at one end to the telescopic pole 102 and a hose 104 running through the pole 102 and at the other end to a dispensing head 108. The hose 104 is connected to a water supply 112 and the user is able to clean windows in the conventional fashion. However, with the system of the invention, the user is able to turn the supply of water to the dispensing head 108 on and off by using the valve system 116. As can be seen from FIG. 3, to turn the water supply on and off, the user pulls on the length of hose 104 protruding from a proximal end portion 106b of the pole 102 (as indicated by the downwards arrow) causing the valve 110 to slide in housing 118 and switch states. On release of the hose 104, the valve 110 returns to its original position in housing 118.

In this way, the portion of the hose 104 located at the proximal end of the pole 102 acts as an element for operating the valve 110 that remains located at the proximal end portion of the pole as the telescopic pole is extended and retracted.

Accordingly, the user can turn the water on and off as he/she transfers the system between windows, or the like, saving water, without placing the pole 102 in an unsafe position or having to over reach to operate the valve. Therefore, a cleaner using the fluid delivery system may switch off the flow of water more regularly saving water and reducing the amount of ionic resin required to filter the water.

The valve system 116 may be supplied as a kit of parts for retrofitting to an existing telescopic pole 102.

It will be understood that various modification and alterations can be made to the described embodiment without departing from the invention as defined in the claims.

1-15. (canceled)

16. A fluid delivery system comprising:
a telescopic pole having a hose running therethrough, a distal end of the pole arranged to be connected to or comprising a dispensing head;
a valve for controlling the flow of fluid from the hose to the dispensing head; and
an valve operating element located at a proximal end portion of the pole to operate the valve, the element arranged to remain located at the proximal end portion of the pole as the telescopic pole is extended and retracted.

17. The fluid delivery system according to claim 16, wherein the element for operating the valve activation mechanism is the hose, the hose connected to the valve such that pulling on the hose operates the valve.

18. The fluid delivery system according to claim 16, wherein the valve is located at a distal end portion of the pole and may be arranged to fluidly connect the hose to the dispensing head.

19. The fluid delivery system according to claim 16, wherein the valve is arranged for sliding movement, sliding movement of the valve causing the valve to switch between an on state allowing fluid flow to the dispense head and an off state preventing fluid flow to the dispense head.

20. The fluid delivery system according to claim 19, wherein the valve and hose are arranged such that the user pulling on the hose causes sliding movement of the valve.

21. The fluid delivery system according to claim 19, further comprising a valve activation mechanism responsive to the sliding movement of the valve to switch the valve between the on and off states.

22. The fluid delivery system according to claim 21, further comprising a valve member of the valve that is operated by rotation and the valve activation mechanism is arranged to convert linear sliding movement of the valve into rotational movement of the valve member.

23. The fluid delivery system according to claim 22, wherein the valve activation mechanism comprises a ratchet mechanism that causes sufficient rotational movement of the valve member to switch states when the valve slides in one linear direction but not the other.

24. The fluid delivery system according to claim 23, wherein the valve activation mechanism comprises a plurality of radial arms connected with the valve member and an abutment member arranged such that movement of the valve in one linear direction causes one of the plurality of arms to catch on the abutment member to convert the sliding movement into sufficient rotation of the valve member to cause the valve to change states, whereas upon movement of the valve in the other linear direction the arm slides over the abutment member such that any resultant rotation of the valve member is insufficient to cause the valve to change states.

25. The fluid delivery system according to claim 24, wherein the plurality of arms and/or the abutment member are arranged to resiliently deform or pivot on engagement with the abutment member/one of the plurality of arms to allow the arm to slide past the abutment member.

26. The fluid delivery system according to claim 16, wherein the valve is biased in the linear direction away from the proximal end portion of the pole.

27. A valve system for a fluid delivery system, comprising:
a valve for insertion in or on a telescopic pole and for connection to a hose running through the pole such that the valve is caused to switch states when the hose is pulled by the user.

28. A kit of parts for forming a valve system, comprising:
a valve activation mechanism connectable to a valve received in a housing such that the valve can slide therein and, the valve activation mechanism arranged to be responsive to the sliding movement of the valve to switch the valve between the on and off states.
